(19) United States
(12) Patent Application Publication
(10) Pub. No.: US 2014/0080507 A1
(43) Pub. Date: Mar. 20, 2014

(54) TERMINAL APPARATUS, POSITION REGISTRATION METHOD, AND NON-TRANSITORY COMPUTER-READABLE STORAGE MEDIUM

(71) Applicant: YAHOO JAPAN CORPORATION, Tokyo (JP)

(72) Inventors: Shinsuke SATOU, Tokyo (JP); Mitsuru MUGUCHI, Tokyo (JP); Satoko TAKIGUCHI, Tokyo (JP); Chie KIKUCHI, Tokyo (JP)

(73) Assignee: YAHOO JAPAN CORPORATION, Tokyo (JP)

(21) Appl. No.: 13/966,709

(22) Filed: Aug. 14, 2013

(30) Foreign Application Priority Data
Sep. 18, 2012 (JP) 2012-204769

(51) Int. Cl. H04W 4/02

(52) U.S. Cl. CPC H04W 4/025
USPC 455/456.1

(57) ABSTRACT

A terminal apparatus of the present application includes a position acquiring unit, a searching unit, and a transmitting unit. The position acquiring unit acquires position information on the location of the terminal apparatus. The searching unit searches other terminal apparatus located near the terminal apparatus through short range communication. The transmitting unit transmits the position information acquired by the position acquiring unit to a predetermined server apparatus, as the current position of the terminal apparatus and the other terminal apparatus searched by the searching unit.

### CROSS-REFERENCE TO RELATED APPLICATIONS

The present application claims priority to and incorporates by reference the entire contents of Japanese Patent Application No. 2012-204769 filed in Japan on Sep. 18, 2012.

### BACKGROUND OF THE INVENTION

1. Field of the Invention

The present invention relates to a terminal apparatus, a position registration method, and a non-transitory computer-readable storage medium.

2. Description of the Related Art

Recently, current position registration is performed by transmitting a location to a predetermined server apparatus using a mobile terminal such as a cellular phone. Such registration of a current position is referred to as check-in, position registration, etc. For example, a user performs position registration using a mobile terminal to disclose his/her moving history on his/her web page such as Twitter (registered trademark) or a weblog (hereinafter referred to as a blog), or to notify friends of his/her location. As a technique related to position registration, there is known a technique of sharing information on a location among users (see Japanese Laid-open Patent Publication No. 2010-182303).

However, the above-mentioned conventional technique has a problem of bothering a user in position registration. To be more specific, there occurs an error in position information acquired by a function of the global position system (GPS), etc. Upon acquiring the position information in accordance with user operation, the mobile terminal searches establishments, etc., near the location in accordance with the position information to prompt a user to select his/her location among the searched establishments, etc. That is, the user is required, in position registration, to confirm operation for starting positioning and operation for selecting a location among search results, and such operation requires user's efforts.

Some mobile terminals automatically and periodically transmit position information to a server apparatus without receiving any user operation. However, the technique of transmitting automatically and periodically the position information is not preferable in terms of leaks of personal information, etc. Thus, there is actually used widely a method of performing position registration based on user's intention, as the example described above. The technique disclosed in Japanese Laid-open Patent Publication No. 2010-182303 is merely a technique of sharing information on a position among users, and is not sufficient to reduce user's efforts required in position registration.

### SUMMARY OF THE INVENTION

According to one aspect of an embodiment, a terminal apparatus includes a position acquiring unit which acquires position information on a location of the terminal apparatus, a searching unit which searches a first other terminal apparatus located near the terminal apparatus through short range communication, and a transmitting unit which transmits the position information acquired by the position acquiring unit to a predetermined server apparatus, as the current position of the terminal apparatus and the first other terminal apparatus searched by the searching unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining an example of position registration processing of an embodiment of the present application;

FIG. 2 is a diagram illustrating a configuration example of a position registration system of the embodiment;

FIG. 3 is a diagram illustrating a configuration example of a user terminal of the embodiment;

FIG. 4 is a diagram illustrating an example of processing by a determining unit of the embodiment; and

FIG. 5 is a flowchart illustrating position registration processing by the user terminal of the embodiment.

### DETAILED DESCRIPTION OF THE PREFERRED EMBODIMENTS

The following describes a mode of implementation (hereinafter, referred to as an “embodiment”) of a terminal apparatus, a position registration method, and a position registration program of the present application in detail with reference to the enclosed drawings. The embodiment does not limit the terminal apparatus, the position registration method, and the position registration program of the present application. Moreover, the same parts are represented with the same symbols in the embodiment, and the overlapped explanation is omitted.

1. Position Registration Processing

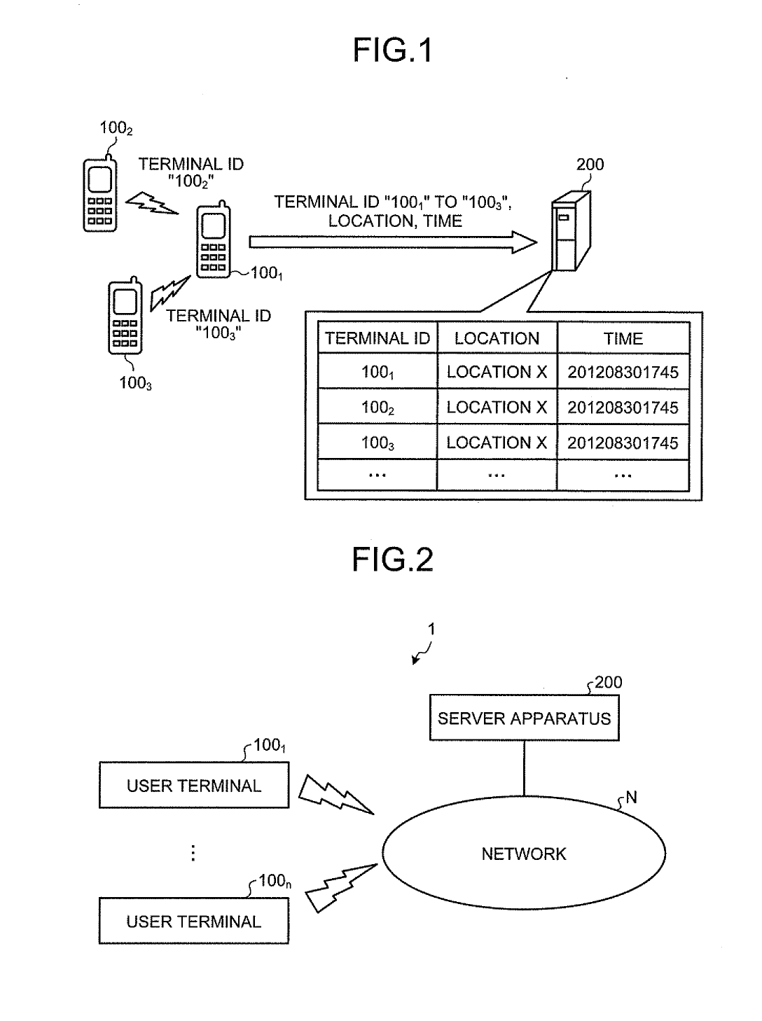

First, the position registration processing of the embodiment is described using FIG. 1. FIG. 1 is a diagram for explaining an example of position registration processing of the embodiment. In the example illustrated in FIG. 1, user terminals 100₁ to 100₃ are cellular phones (smartphones, for example), personal digital assistants (PDAs), etc. A server apparatus 200 receives locations from the user terminals 100₁ to 100₃, and thereby registering therein the locations of the user terminals 100₁ to 100₃.

It is assumed here that the user terminal 100₁ illustrated in FIG. 1 performs position registration in accordance with user operation. In this case, the user terminal 100₁ performs positioning of the user terminal 100₁ by acquiring position information. The user terminal 100₁ then searches places (establishments, etc.) near the determined location to prompt the user to select his/her location among the searched places.

In the position registration processing of the embodiment, the user terminal 100₁ searches another user terminal located near the terminal 100₁ through short range communication. In the example of FIG. 1, the terminal 100₁ has searched the user terminals 100₂ and 100₃. In this case, the terminal 100₁ receives a terminal ID “100₂” for identifying the user terminal 100₂ from the user terminal 100₂, and a terminal ID “100₃” for identifying the user terminal 100₃ from the user terminal 100₃. Then, the user terminal 100₁ performs position registration of the terminal apparatus (user terminal 100₁) for itself. In addition, the user terminal 100₁ performs position registration as a substitute of the user terminals 100₂ and 100₃ using the terminal IDs “100₂” and “100₃”.

To be more specific, the user terminal 100₁ transmits, to the server apparatus 200, not only the terminal ID “100₁” for identifying the terminal apparatus but also the terminal ID “100₂” of the user terminal 100₂ and the terminal ID “100₃” of the user terminal 100₃ in addition to a location X selected by the user as described above and time that is current time, as illustrated in FIG. 1. Thus, the server apparatus 200 registers the location X of the user terminals 100₁ to 100₃ and the time in association with respective terminal IDs.

In the position registration processing of the embodiment, when the user terminal 100₁ performs position registration as the terminal apparatus, it also performs position registration as a substitute of the other user terminals 100₂ and 100₃ located near the user terminal 100₁, as described above. Thus, the position registration processing of the embodiment can reduce efforts of users of the user terminals 100₂ and 100₃ in position registration.

FIG. 1 illustrates an example in which the user terminal 100₁ performs position registration as a substitute. However, the user terminal 100₂ may perform position registration of the user terminals 100₁ and 100₃ as a substitute, or the user terminal 100₃ may perform position registration of the user terminals 100₁ and 100₂ as a substitute. Moreover, although three user terminals 100₁ to 100₃ are illustrated in FIG. 1, the number of user terminals may be two, or may be four or more.

The position registration processing as a substitute has been described concisely using FIG. 1. Here, the user terminal 100₁ may determine whether users have a friend relation therebetween and perform position registration as a substitute of only a user terminal of a user having a friend relation. Moreover, the user terminal 100₁ may perform position registration as a substitute of the other user terminals 100₂ and 100₃ only when it receives notification indicating that the position registration is permitted from the user terminals 100₂ and 100₃. The following describes a position registration system achieving such position registration processing in detail.

2. Configuration of Position Registration System

FIG. 2 is a diagram illustrating a configuration example of the position registration system of the embodiment. As illustrated in FIG. 2, the position registration system 1 of the embodiment includes the user terminals 100₁ to 100ₙ, and the server apparatus 200. The user terminals 100₁ to 100ₙ and the server apparatus 200 are connected through a network N so that they can establish wireless or wired communication.

The user terminals 100₁ to 100ₙ have a GPS receiving function, and acquire the current position of the user terminals 100₁ to 100ₙ. Then, when the user terminals 100₁ to 100ₙ perform position registration for themselves, the user terminals also perform position registration as a substitute of another user terminal located near themselves. Here, the user terminals 100₁ to 100ₙ have the same function, and thus they may be referred to collectively as a “user terminal 100” when there is no need to distinguish the user terminals 100₁ to 100ₙ among them.

Upon receiving a location, time, etc., from the user terminal 100, the server apparatus 200 registers the location of the user terminal 100. The server apparatus 200 corresponds to a Twitter (registered trademark) server or a blog server, for example, and has a function of disclosing the location, the time, etc., received from the user terminal 100 on Twitter or a blog.

FIG. 2 illustrates an example in which the position registration system 1 includes one server apparatus 200. However, the position registration system 1 may include a plurality of server apparatuses 200.

3. Configuration of User Terminal

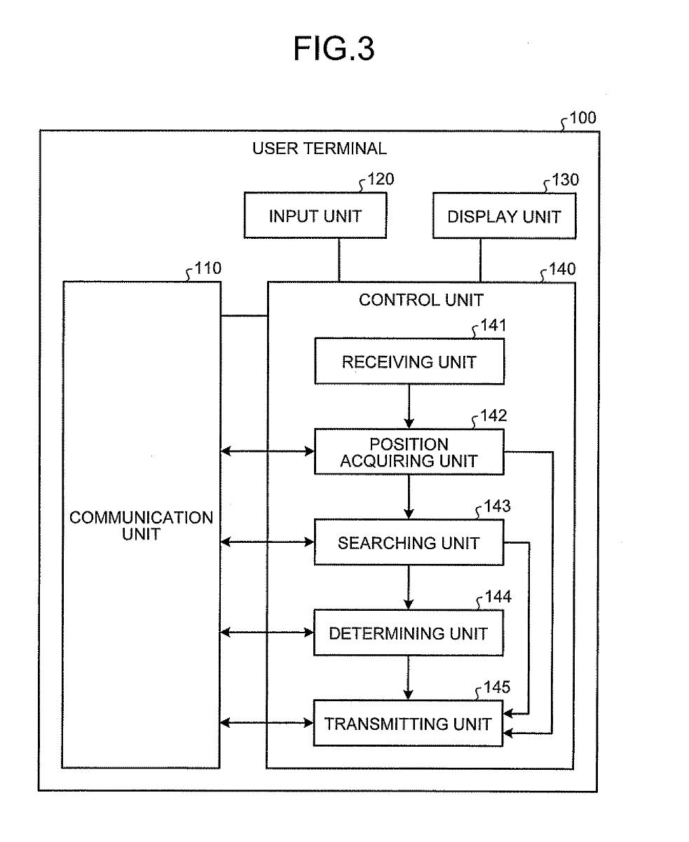

Next, the user terminal 100 illustrated in FIG. 2 is described using FIG. 3. FIG. 3 is a diagram illustrating a configuration example of the user terminal 100 of the embodiment. As illustrated in FIG. 3, the user terminal 100 has a communication unit 110, an input unit 120, a display unit 130, and a control unit 140.

Regarding the Communication Unit 110

The communication unit 110 is connected to the network N, and transmits and receives information to and from the server apparatus 200 through the network N. The communication unit 110 establishes wireless connection with the network N. The communication unit 110 also performs short range communication with another user terminal without involving the network N. For example, the communication unit 110 performs direct communication with other user terminals through infrared communication, etc., without involving a base station, etc.

Regarding the Input Unit 120 and the Display Unit 130

The input unit 120 is an input device receiving various kinds of operation from a user. The input unit 120 is achieved by a cursor key or a numeric keypad, for example. The display unit 130 is a display device for displaying various kinds of information. The display unit 130 is achieved by a liquid crystal display, for example. When a touch panel is adopted in the user terminal 100, the input unit 120 and the display unit 130 are integrated with each other.

Regarding the Control Unit 140

The control unit 140 is achieved in a manner that a central processing unit (CPU) or a micro processing unit (MPU), for example, executes a computer program stored in an internal storage device (corresponding to one example of the position registration program) with a random-access memory (RAM) as a work area, for example. The control unit 140 is achieved by an integrated circuit such as an application specific integrated circuit (ASIC) or a field programmable gate array (FPGA), for example.

The control unit 140 has a receiving unit 141, a position acquiring unit 142, a searching unit 143, a determining unit 144, and a transmitting unit 145, as illustrated in FIG. 3, and achieves or executes functions and action of information processing described in the following. The internal configuration of the control unit 140 is not limited to one illustrated in FIG. 3, and may be another configuration as long as the information processing described later is performed.

Regarding the Receiving Unit 141

The receiving unit 141 receives operation for registering position information on the location of the user terminal 100 from the user. The receiving unit 141 receives operation for starting position registration processing when a position registration menu, etc., displayed on the display unit 130 is selected through the input unit 120, for example.

Regarding the Position Acquiring Unit 142

When the receiving unit 141 receives operation for registering the position information, the position acquiring unit 142 acquires position information on the location of the user terminal 100. To be more specific, the position acquiring unit 142 receives radio waves transmitted from GPS satellites, and acquires position information (latitude and longitude, for example) of the user terminal 100 based on the received radio waves.

Regarding the Searching Unit 143

When the receiving unit 141 receives operation for registering position information, the searching unit 143 searches another user terminal located near the user terminal 100 through short range communication. To be more specific, the searching unit 143 controls the communication unit 110 so as to perform short range communication with another user terminal located near the user terminal 100. When the searching unit 143 succeeds in short range communication, it receives a terminal ID of the other user terminal through such short range communication. When the searching unit 143 fails in short range communication, it determines that there is no user terminal near the user terminal 100.

When the searching unit 143 succeeds in short range communication with the other user terminal, it may inquire of the other user terminal about whether the registration of position information is permitted. Moreover, when an inquiry about whether the registration of position information is permitted is received from the searching unit 143 of the other user terminal, the searching unit 143 may display, on the display unit 130, a screen for confirming with the user whether he/she permits the substitute registration of position information by the other user terminal, and notify the other user terminal of the selection of the user on the screen through short range communication. To be more specific, when operation for permitting substitute registration is performed on the screen, the searching unit 143 notifies the other user terminal of the fact that the registration of position information is permitted through short range communication. By contrast, when operation for denying substitute registration is performed, the searching unit 143 notifies the other user terminal of the fact that the registration of position information is denied through short range communication. Such notification processing is not necessarily performed by the searching unit 143, and may be performed by another processing unit (notifying unit, for example) (not illustrated) of the control unit 140.

Regarding the Determining Unit 144

The determining unit 144 determines whether a user of another user terminal searched by the searching unit 143 and the user of the user terminal 100 as a terminal apparatus have a friend relation. The following describes the determination processing by the determining unit 144 using some examples.

It is assumed, for example, that the searching unit 143 has a function of notifying whether substitute registration is permitted as the example described above. In this case, when notification indicating that the registration of position information is permitted is received from the searching unit 143 of the other user terminal searched by the searching unit 143 through short range communication, the determining unit 144 determines that the user of the user terminal 100 and a user of the other user terminal have a friend relation. In this manner, with the notification of permission of substitute registration through short range communication, it is possible to authenticate whether substitute registration between users actually located near to each other is permitted, and only a user actually located near can perform the registration of position information as a substitute. That is, with the notification of permission of substitute registration through short range communication, it is possible that only users located near to each other can share position information. Moreover, with the substitute registration of position information, the user of the other user terminal can register position information on the terminal apparatus (the other user terminal) merely by performing operation (one touch operation, for example) for permitting substitute registration without searching the position.

Alternatively, the determining unit 144 acquires social group information from a predetermined social networking service (SNS) server, etc., and determines whether the users of user terminals have a friend relation based on the acquired social group information, for example. To be more specific, SNS users form a social group among friends. This social group is referred to as a friend list, etc. When the user of the user terminal 100 and a user of another user terminal searched by the searching unit 143 belong to a same social group based on the social group information acquired from the SNS server, the determining unit 144 determines that both users have a friend relation.

Alternatively, the determining unit 144 acquires communication information from a predetermined SNS server, etc., and determines whether the users of user terminals have a friend relation based on the acquired community information, for example. To be more specific, SNS users form a community among users having a same hobby or preference. When the user of the user terminal 100 and a user of the other user terminal searched by the searching unit 143 belong to a same community based on the community information acquired from the SNS server, the determining unit 144 determines that both users have a friend relation.

Alternatively, the determining unit 144 acquires public information indicating a range of disclosure of information of a user of another user terminal from a predetermined SNS server, etc., and determines whether the users of user terminals have a friend relation based on the acquired public information, for example. To be more specific, SNS users may set a range in which articles such as a diary posted by himself/herself are disclosed. For example, users disclose such articles within a range of friends or a range of friends of friends, or without any conditions. When the user of the user terminal 100 is included in a range of disclosure of a user of another user terminal searched by the searching unit 143 based on the public information acquired by the SNS server, the determining unit 144 determines that both users have a friend relation.

The SNS server described above may be the server apparatus 200, or other server apparatuses omitted in FIG. 2

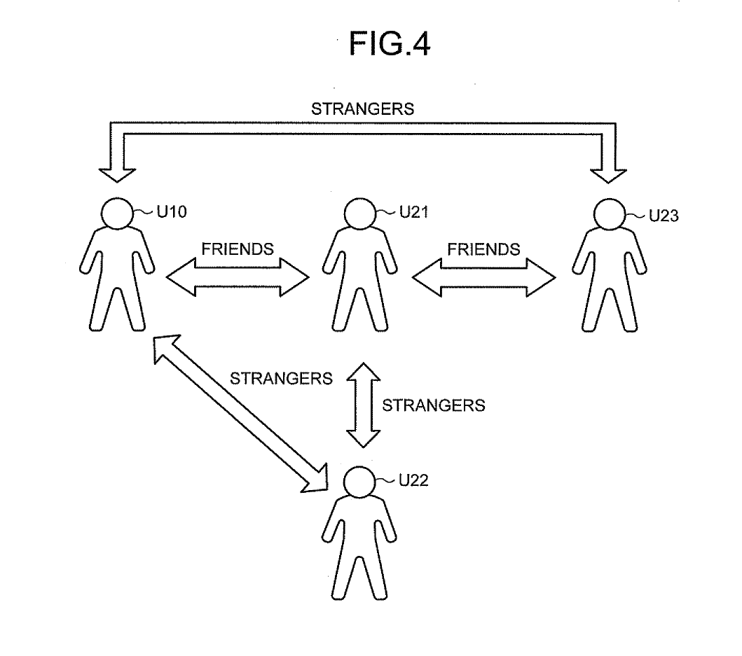

Here, one example of processing by the determining unit 144 of the embodiment is described using FIG. 4. In the example illustrated in FIG. 4, a user U10 is a user of the user terminal 100. Users U21 to U23 are users of other user terminals searched by the searching unit 143 of the user terminal 100.

As illustrated in FIG. 4, it is assumed that the user U10 and the user U21 belong to a same social group, the user U10 and the user U22 do not belong to a same social group, and the user U10 and the user U23 do not belong to a same social group. When such social group information is acquired from the SNS server, the determining unit 144 determines that the user U10 and the user U21 have a friend relation and that there is no friend relation between the user U10 and the user U22 and between the user U10 and the user U23.

In the example illustrated in FIG. 4, the user U21 and the user U23 belong to a same social group, and the user U21 and the user U22 do not belong to a same social group. That is, the user U10 and the user U23 who have a friend relation with a friend through the user U21, while the user U10 and the user U22 do not have a friend relation with a friend through the user U21. In this case, the determining unit 144 may determine that the user U10 and the user U23 have a friend relation regarding that friends of friends are also friends.

FIG. 4 exemplifies the friend relation based on the social group. However, the determining unit 144 can perform the same determination processing with respect to the friend relation based on communication information or public information. For example, when the user U21 discloses articles, etc., to the user 10, and the user U22 and the user U23 do not disclose articles, etc., to the user U10, the determining unit 144 determines that the user U10 and the user U21 have a friend relation and that there is no friend relation between the user U10 and the user U22 and between the user U10 and the user U23. Moreover, when the user U22 does not disclose articles, etc., to the user U21 and the user U23 discloses articles, etc., to the user U21 in this example, the determining unit 144 may determine that the user U21 and the user U22 do not have a friend relation, and that the user U21 and the user U23 have a friend relation.

Regarding the Transmitting Unit 145

The transmitting unit 145 transmits position information acquired by the position acquiring unit 142 to the server apparatus 200, as the current position of the user terminal 100 as the terminal apparatus and other user terminals searched by the searching unit 143.

To be more specific, when there is another user terminal of another user determined to have a friend relation by the determining unit 144 among the other user terminals searched by the searching unit 143, the transmitting unit 145 transmits the terminal ID of the user terminal 100 as the terminal apparatus, a terminal ID of the other user terminal of the other user who has a friend relation, and the position information acquired by the position acquiring unit 142 to the server apparatus 200. That is, the transmitting unit 145 performs position registration processing of not only the user terminal 100 as the terminal apparatus but also the other user terminal of the other user who has a friend relation as a substitute.

When there is no other user terminal of another user determined to have a friend relation by the determining unit 144 although there are other user terminals searched by the searching unit 143, the transmitting unit 145 transmits an terminal ID of the user terminal 100 as the terminal apparatus and the position information acquired by the position acquiring unit 142 to the server apparatus 200. That is, the transmitting unit 145 does not perform position registration processing as a substitute of other user terminals of users who are not friends.

4. Position Registration Processing

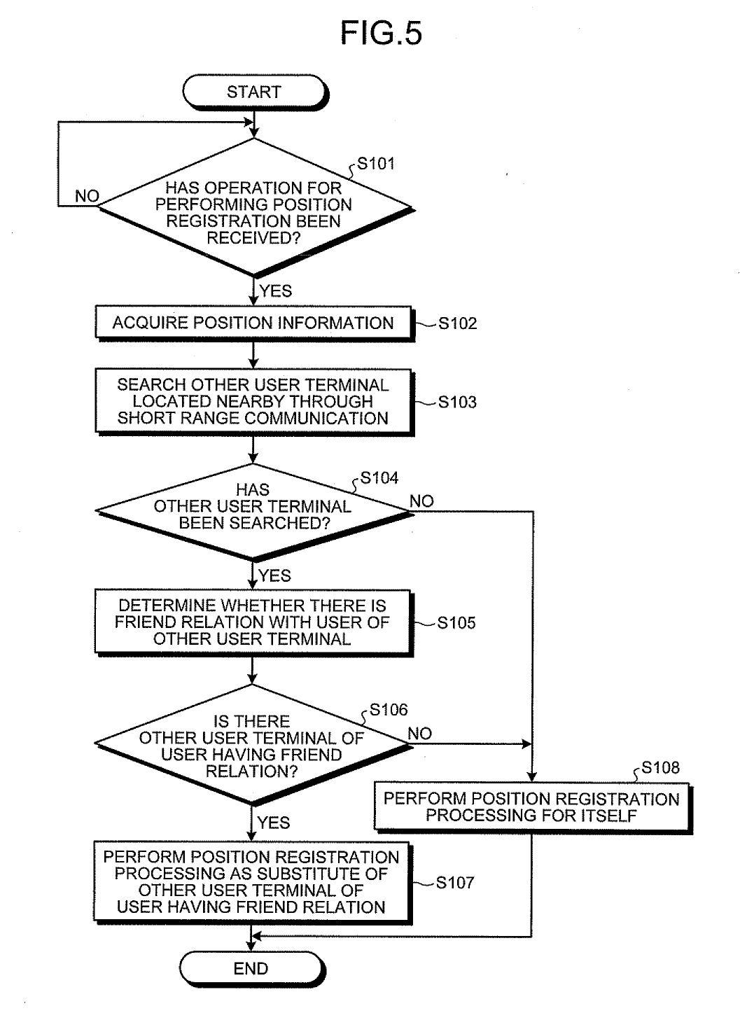

Next, the position registration processing by the user terminal 100 of the embodiment is described using FIG. 5. FIG. 5 is a flowchart illustrating position registration processing by the user terminal 100 of the embodiment.

As illustrated in FIG. 5, the receiving unit 141 of the user terminal 100 determines whether operation for performing position registration has been received (Step S101). Here, when the receiving unit 141 has not received the operation for performing position registration (No at Step S101), it waits for the reception of the operation.

When the receiving unit has received the operation for performing position registration (Yes at Step S101), the position acquiring unit 142 acquires position information on the location of the user terminal 100 (Step S102).

Subsequently, the searching unit 143 searches another user terminal located near the user terminal 100 through short range communication (Step S103). Then, when the searching unit 143 has searched the other user terminal (Yes at Step S104), the determining unit 144 determines whether a user of the other user terminal and the user of the user terminal 100 as the terminal apparatus have a friend relation (Step S105).

When there is another user terminal of a user determined to have a friend relation by the determining unit 144 (Yes at Step S106), the transmitting unit 145 performs position registration processing as a substitute of the other user terminal of the user who has a friend relation (Step S107). To be more specific, the transmitting unit 145 transmits the position information acquired by the position acquiring unit 142 to the server apparatus 200, as the current position of the user terminal 100 as the terminal apparatus and the other user terminal of the user who has a friend relation.

When the searching unit 143 has not searched another user terminal (No at Step S104), or when there is no other user terminal of a user determined to have a friend relation by the determining unit 144 (No at Step S106), the transmitting unit 145 transmits the position information acquired by the position acquiring unit 142 to the server apparatus 200, as the current position of the user terminal 100 as the terminal apparatus (Step S108).

5. Modifications

The position registration system 1 of the embodiment described above may be implemented in other various modes other than the above-mentioned embodiment. Thus, the following describes other embodiments of the position registration system 1.

5.1 Friend Relation Determination Processing

The above embodiment exemplifies an example in which the determining unit 144 determines whether there is a friend relation based on social group information, communication information, or public information, for example. However, the processing by the determining unit 144 is not limited thereto.

For example, the determining unit 144 may determine whether there is a friend relation based on a distance between the user terminal 100 as the terminal apparatus and another user terminal searched by the searching unit 143. To be more specific, when a distance between the user terminal 100 and another user terminal is equal to or smaller than a predetermined distance threshold, the determining unit 144 may determine that both users have a friend relation.

Alternatively, the determining unit 144 may determine whether there is a friend relation based on the number of short range communication performed between the user terminal 100 as the terminal apparatus and another user terminal searched by the searching unit 143, for example. To be more specific, the searching unit 143 of the user terminal 100 performs short range communication periodically (each five minutes, for example). When the number of short range communication performed successively between the user terminal 100 and another user terminal is equal to or more than a predetermined number-of-times threshold, the determining unit 144 may determine that both users have a friend relation.

5.2 Others

Among the various kinds of processing described in the embodiment, the processing performed automatically in the description may be entirely or partially performed manually, or the processing performed manually in the description may be entirely or partially performed automatically by known methods. In addition, the processing procedures, concrete terms, and various kinds of information including data and parameters in the description or the drawings can be modified arbitrarily unless otherwise specified. For example, the various kinds of information illustrated in the drawings are not limited to one illustrated therein.

The illustrated components of each apparatus are based on the functional concept, and are not necessarily configured physically as illustrated in the drawings. That is, the concrete form of distribution and integration of the apparatus is not limited to the form illustrated in the drawings, and the entire of the apparatus or one part thereof may be distributed or integrated functionally or physically in an arbitrary unit, depending on various loads, a use state, etc.

6. Advantages

As described above, the user terminal 100 of the embodiment (corresponding to one example of a terminal apparatus) has the position acquiring unit 142, the searching unit 143, and the transmitting unit 145. The position acquiring unit 142 acquires position information on the location of the user terminal 100. The searching unit 143 searches other user terminals located near the user terminal 100 through short range communication. The transmitting unit 145 transmits the position information acquired by the position acquiring unit 142 to the server apparatus 200, as the current position of the user terminal 100 and other user terminals searched by the searching unit 143.

In this manner, when the user terminal 100 of the embodiment performs position registration as the terminal apparatus, it also performs position registration as a substitute of another user terminal located near the user terminal 100. Consequently, the user terminal 100 of the embodiment can reduce efforts of a user of the other user terminal in position registration.

The determining unit 144 of the user terminal 100 of the embodiment determines whether users of other user terminals searched by the searching unit 143 and the user of the user terminal 100 have friend relations. The transmitting unit 145 transmits position information on another user terminal of a user determined to have a friend relation with the user of the user terminal 100 by the determining unit 144, among other user terminals searched by the searching unit 143, to the server apparatus 200.

In this manner, the user terminal 100 of the embodiment performs position registration as a substitute of only different user terminals of users who have a friend relation, which makes it possible to prevent leaks of personal information of the other user terminals, etc., and reduce efforts of the user of the other user terminal in position registration.

When notification indicating that the registration of position information is permitted is received from another user terminal searched by the searching unit 143, the determining unit 144 of the user terminal 100 of the embodiment determines that a user of the other user terminal and the user of the user terminal 100 have a friend relation.

In this manner, the user terminal 100 of the embodiment performs position registration as a substitute based on intention of the user of the other user terminal. Thus, it is possible to prevent leaks of personal information of the other user terminal, etc., more securely, and reduce efforts of the user of the other user terminal in position registration.

When a user of another user terminal searched by the searching unit 143 and the user of the user terminal 100 belong to the same social group or the same community in a predetermined social networking service, the determining unit 144 of the user terminal 100 of the embodiment determines that they have a friend relation.

When a user of another user terminal searched by the searching unit 143 discloses articles posted in a predetermined social networking service to the user of user terminal 100, the determining unit 144 of the user terminal 100 of the embodiment determines that the user of the other user terminal and the user of the user terminal 100 have a friend relation.

When the number of short range communication performed successively between the user terminal 100 and another user terminal is equal to or more than a predetermined number-of-times threshold, the determining unit 144 of the user terminal 100 of the embodiment determines that a user of the other user terminal and the user of the user terminal 100 have a friend relation.

In this manner, the user terminal 100 of the embodiment can accurately determine whether there is a friend relation. Thus, it is possible to prevent leaks of personal information of the other user terminal, etc., more securely, and reduce efforts of the user of the other user terminal in position registration.

In the above, some embodiments of the present application have been described in detail based on the drawings. However, they are merely examples, and the invention can be implemented in other modes by applying various changes and modifications to the aspect described in the summary of the invention based on the knowledge of a person skilled in the art.

The server apparatus 200 described above may be achieved by a plurality of server computers. Moreover, the configuration can be changed flexibly as some functions are achieved by calling an external platform, etc., through an application programming interface or network computing, for example.

The “device” described in claims can be replaced with the “section, module, or unit”, the “circuit”, etc. For example, the receiving device can be replaced with a receiving unit or a receiving circuit.

An aspect of the embodiment has an advantage of reducing user's efforts required in position registration.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal apparatus used by a user, the terminal apparatus comprising:
a position acquiring unit which acquires position information on a location of the terminal apparatus;
a searching unit which searches a first other terminal apparatus located near the terminal apparatus through short range communication; and
a transmitting unit which transmits the position information acquired by the position acquiring unit to a predetermined server apparatus, as the current position of the terminal apparatus and the first other terminal apparatus searched by the searching unit.

2. The terminal apparatus according to claim 1, further comprising:
a determining unit which determines whether a first other user of the first other terminal apparatus searched by the searching unit and the user of the terminal apparatus have a friend relation, wherein
the transmitting unit transmits the position information of the first other terminal apparatus of the first other user determined to have a friend relation with the user of the terminal apparatus by the determining unit, among other terminal apparatuses searched by the searching unit, to the predetermined server apparatus.

3. The terminal apparatus according to claim 2, wherein
the determining unit determines, when notification indicating that registration of position information is permitted is received from the first other terminal apparatus searched by the searching unit through the short range communication, that the first other user of the first other terminal apparatus and the user of the terminal apparatus have a friend relation.

4. The terminal apparatus according to claim 1, further comprising:
a notifying unit that displays a screen on which the user is prompted to input whether registration is permitted when an inquiry about whether the registration of position information is permitted is received from a second other terminal apparatus, and notifies the second other terminal apparatus that the registration is permitted through the short range communication when the user inputs that the registration is permitted.

5. The terminal apparatus according to claim 2, wherein
the determining unit determines, when the first other user of the first other terminal apparatus searched by the searching unit and the user of the terminal apparatus belong to a same group in a predetermined social networking service, that the first other user of the first other terminal apparatus and the user of the terminal apparatus have a friend relation.

6. The terminal apparatus according to claim 2, wherein
the determining unit determines, when the first other user of the first other terminal apparatus searched by the searching unit discloses articles posted in a predetermined social networking service to the user of the terminal apparatus, that the first other user of the first other terminal apparatus and the user of the terminal apparatus have a friend relation.

7. The terminal apparatus according to claim 2, wherein
the determining unit determines, when number of the short range communication performed successively between the terminal apparatus and the first other terminal apparatus is equal to or more than a predetermined number-of-times threshold, that the first other user of the first other terminal apparatus and the user of the terminal apparatus have a friend relation.

8. A position registration method performed by a terminal apparatus, the position registration method comprising:
acquiring position information on a location of the terminal apparatus;
searching other terminal apparatus located near the terminal apparatus through short range communication; and
transmitting the position information acquired at the acquiring to a predetermined server apparatus, as a current position of the terminal apparatus and the other terminal apparatus searched at the searching.

9. The position registration method according to claim 8, further comprising:
determining whether other user of the other terminal apparatus searched at the searching and the user of the terminal apparatus have a friend relation, wherein
the transmitting includes transmitting the position information of the other terminal apparatus of the other user determined to have a friend relation with the user of the terminal apparatus at the determining, among other terminal apparatuses searched at the searching, to the predetermined server apparatus.

10. The position registration method according to claim 9 wherein
the determining includes determining, when notification indicating that registration of position information is permitted is received from the other terminal apparatus searched at the searching through the short range communication, that the other user of the other terminal apparatus and the user of the terminal apparatus have a friend relation.

11. The position registration method according to claim 9, wherein
the determining includes determining, when the other user of the other terminal apparatus searched at the searching and the user of the terminal apparatus belong to a same group in a predetermined social networking service, that the other user of the other terminal apparatus and the user of the terminal apparatus have a friend relation.

12. The position registration method according to claim 9, wherein
the determining includes determining, when the other user of the other terminal apparatus searched at the searching discloses articles posted in a predetermined social networking service to the user of the terminal apparatus, that the other user of the other terminal apparatus and the user of the terminal apparatus have a friend relation.

13. The position registration method according to claim 9, wherein
the determining includes determining, when number of the short range communication performed successively between the terminal apparatus and the other terminal apparatus is equal to or more than a predetermined number-of-times threshold, that the other user of the other terminal apparatus and the user of the terminal apparatus have a friend relation.

14. A non-transitory computer-readable storage medium with an executable program stored thereon, wherein the program instructs a computer to perform:
acquiring position information on a location of the terminal apparatus;
searching other terminal apparatus located near the terminal apparatus through short range communication; and
transmitting the position information acquired at the acquiring to a predetermined server apparatus, as a current position of the terminal apparatus and the other terminal apparatus searched at the searching.

15. The non-transitory computer-readable storage medium according to claim 14, further instructing the computer to perform:
determining whether other user of the other terminal apparatus searched at the searching and the user of the terminal apparatus have a friend relation, wherein
the transmitting includes transmitting the position information of the other terminal apparatus of the other user determined to have a friend relation with the user of the terminal apparatus at the determining, among other terminal apparatuses searched at the searching, to the predetermined server apparatus.

16. The non-transitory computer-readable storage medium according to claim 15, wherein
the determining includes determining, when notification indicating that registration of position information is permitted is received from the other terminal apparatus searched at the searching through the short range communication, that the other user of the other terminal apparatus and the user of the terminal apparatus have a friend relation.

17. The non-transitory computer-readable storage medium according to claim 15, wherein
the determining includes determining, when the other user of the other terminal apparatus searched at the searching and the user of the terminal apparatus belong to a same group in a predetermined social networking service, that the other user of the other terminal apparatus and the user of the terminal apparatus have a friend relation.

18. The non-transitory computer-readable storage medium according to claim 15, wherein
the determining includes determining, when the other user of the other terminal apparatus searched at the searching discloses articles posted in a predetermined social networking service to the user of the terminal apparatus, that the other user of the other terminal apparatus and the user of the terminal apparatus have a friend relation.

19. The non-transitory computer-readable storage medium according to claim 15, wherein
the determining includes determining, when number of the short range communication performed successively between the terminal apparatus and the other terminal apparatus is equal to or more than a predetermined number-of-times threshold, that the other user of the other terminal apparatus and the user of the terminal apparatus have a friend relation.
